(19) United States
(12) Patent Application Publication
(10) Pub. No.: US 2023/0162615 A1
(43) Pub. Date: May 25, 2023

(54) Educational System and Platform for Identifying Areas in Which Student is Lagging or Needs Improvement

(71) Applicant: Global Education Exchange Opportunities, Inc., Manati, PR (US)

(72) Inventor: Odette Piñeiro Caballero, Manati, PR (US)

(73) Assignee: Global Education Exchange Opportunities, Inc., Manati, PR (US)

(21) Appl. No.: 18/089,715

(22) Filed: Dec. 28, 2022

Related U.S. Application Data
(60) Provisional application No. 63/282,131, filed on Nov. 22, 2021.

(51) Int. Cl. G09B 7/04; G09B 7/08

(52) U.S. Cl. CPC G09B 7/04; G09B 7/08; G06Q 10/1095

(57) ABSTRACT

An educational system and platform that relates to a technological tool or process that allows an educator to identify the areas or subjects in which student is lagging or needs improvement.

### CROSS-REFERENCE TO RELATED APPLICATION

N/A

### STATEMENT REGARDING FEDERALLY SPONSORED RESEARCH AND DEVELOPMENT

N/A

### BACKGROUND OF THE INVENTION

Traditional education systems provide courses to students irrespective of a student's individual learning preference, ability, or predisposition. Additionally, teaching lessons are usually conducted without regard to a learner's individual learning preference, strengths, or frequency of interaction. The World Economic Forum states that, in the United States, classrooms have a student to teacher ratio of approximately 16:1, whereas in other countries, the same can reach 30:1. This chart shows how student-teacher ratios vary around the world, Sep. 9, 2022; http://www.weforum.org/agenda/, last visited Dec. 19, 2022. According to the Department of Education, “the lower the pupil/teacher ratio, the higher the availability of teacher services for each student.” The Condition of Education 2015, National Center for Education Statistics, US Department of Education, p. 119, n.1. Thus, there is a need for an automated educational system for identifying areas in which student is lagging or needs improvement.

### SUMMARY OF THE INVENTION

The educational system and platform disclosed herein relates to a technological tool or automated process that allows an educator to identify the concept or skill in which student is lagging or needs improvement as well as providing alternatives to address them.

### BRIEF DESCRIPTION OF THE DRAWINGS

FIG. 1 Shows the user login page to access the platform.

FIG. 2 Shows the dashboard for the administrative portal the administrator will use to keep track of the services provided by the platform.

FIG. 3 Shows the school panel for the school principal of the school that is registered within the platform.

FIG. 4 Shows the professor portal.

FIG. 5 Shows the student portal.

FIG. 6 Shows the parent panel.

FIG. 7 Shows impact exams list.

FIG. 8 Shows the new exams page for the professor to create exams.

FIG. 9 Shows a drop-down list categorizing information about the exams.

FIG. 10 Shows how a professor grades and gives feedback to the student's open responses.

FIG. 11 Shows how an exam is administered to the student.

FIG. 12 Shows how the platform gives feedback to the student's closed responses.

FIG. 13 Shows a drop-down list for the multiple available reports.

FIG. 14 Shows the reports by standard for a specific unit.

FIG. 15 Shows the reports by student for a specific group.

FIG. 16 Shows the reports by unit per grade.

FIG. 17 Shows a drop-down list to toggle between sent and received messages within the platform.

FIG. 18 Shows the messages page within the platform.

FIG. 19 Shows the calendar page within the platform.

FIG. 20 Shows the instructional guides available to the professor.

FIG. 21 Shows the response processor for open responses.

FIG. 22 Shows a flowchart of the parallel processes performed by the system on the platform.

FIG. 23 Shows an example of a rubric that students can access when answering questions related to a specific topic or skill.

### DETAILED DESCRIPTION OF THE INVENTION

The educational system disclosed herein relates to a technological tool or automated process that uses a digital platform to allow an educator, teacher or professor to identify, within a reasonable time, the concept or skill in which students are lagging or need improvement, thereby allowing the professor to develop the teaching lesson taking into consideration the particular needs of the group and the students' individual needs. These assessments must be aligned to standards, since assessments must reflect what the students are expected to know and be able to do. The assessments in the present invention are aligned to the educational standards; however, it can be adapted to any other applicable standard as required.

For the purposes of the present disclosure, alignment is defined as the degree to which assessments provide valid and accurate information about the performance of all students in an academic content area at the desired level of detail on the content standards. Individual student assessment allows professors to determine student's competence in specific subject matters and allows for reteaching to ensure that all students master each lesson, especially in math where scope and sequence is crucial. Without appropriate assessment the professor lacks the tools to determine the student's growth and compliance with the standards. For example, when professors receive new students or are assigned a new grade or group at the beginning of an academic year, the professors may determine their teaching strategies based on the students' previous assessments, instead of automatically resorting to a general curriculum that might not address the particular needs of said new students. The system also allows the use of the platform in order for school administrators and professors to identify patterns related to specific groups of students (demographics, classrooms, grades, etc.) in terms of what they lack and need, progress, and effective strategies or exercises chosen by professors that have impact in achieving the desired results.

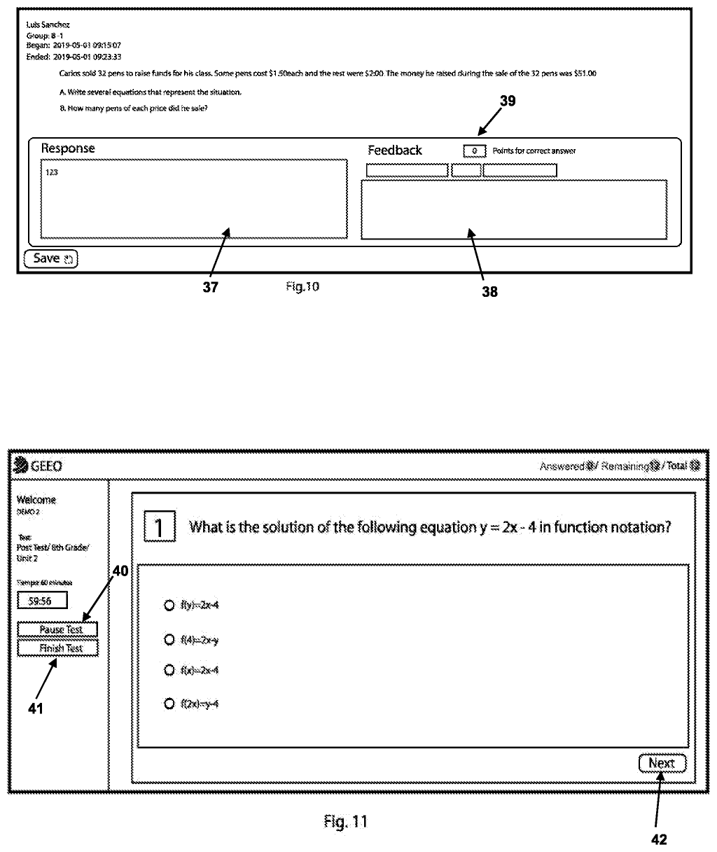

The system comprises three (3) components carried out in the platform. The first component includes a standardized test or impact exam, as shown in FIG. 7 and FIG. 11, aligned to a particular subject's standards and expectations, skills, according to a Curriculum Map. The Curriculum Map is an official document from education authorities detailing important aspects of a unit. These aspects include, but are not limited to: time frame, transfer and acquisition objectives, skills, and the unit summary concepts that the student should master by the end of the unit. This impact exam can be administered in the platform as a pre-test or post-test and the results are available immediately in the platform. This allows the professor to know the areas of lag, according to the skill, unit or concept that is being covered. Specifically, it allows the professor to measure and determine if the student has achieved mastery in a particular lesson in order to continue to the next lesson, since mastery of previous content is required in order to learn and master new content.

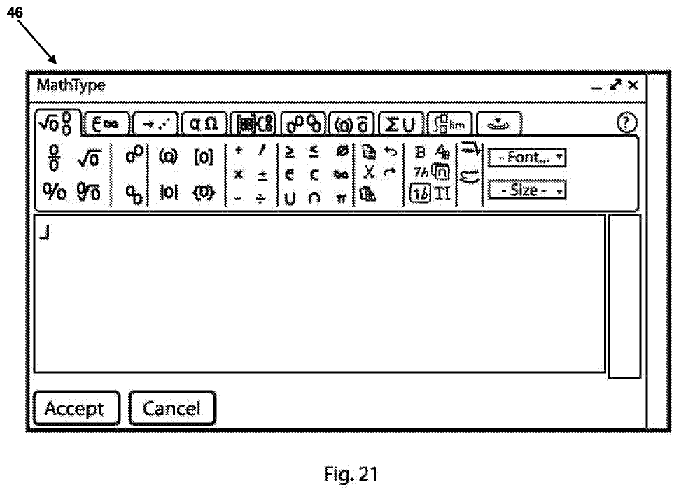

The tests are designed on a plugin that uses a response processor that includes text (words) and other symbols for mathematics and science, as shown in FIG. 21, allowing the integration of symbols, equations, among others, for the writing of the answers that may be required (“open responses”). By “open responses” it is meant answers that the student writes in the platform instead of answers provided by the platform from which the student chooses. The system can allow the platform to generate reports using information from the open responses to determine the most common errors committed by students. For example, a word cloud can be generated showing the words, numbers or other responses most commonly answered for an open response question. This feature allows school administrators and professors to identify patterns that can contribute to teaching opportunities by identifying effective strategies or exercises chosen by professors that have impact in achieving the desired results. For example, the word cloud can be generated by tabulating in a database all the words or numbers received in an open response, and assigning a font size to the word that is equivalent or proportional to the number of times the word is repeated in the specific open response. The results generated from these reports (e.g., word cloud) also allow the professor to identify potential wrong answers for multiple answer questions that can be used in diagnostic tests to quickly recognize learning deficiency patterns observed previously using the word cloud reporting feature. By recognizing learning deficiency patterns early, the professor can implement curriculums previously used to address the identified patterns.

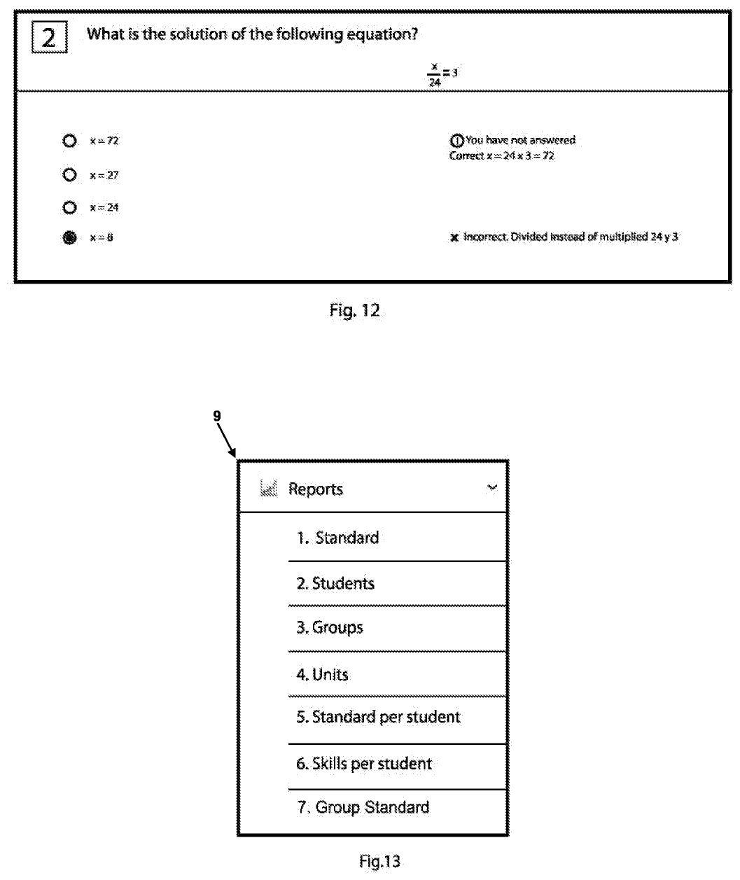

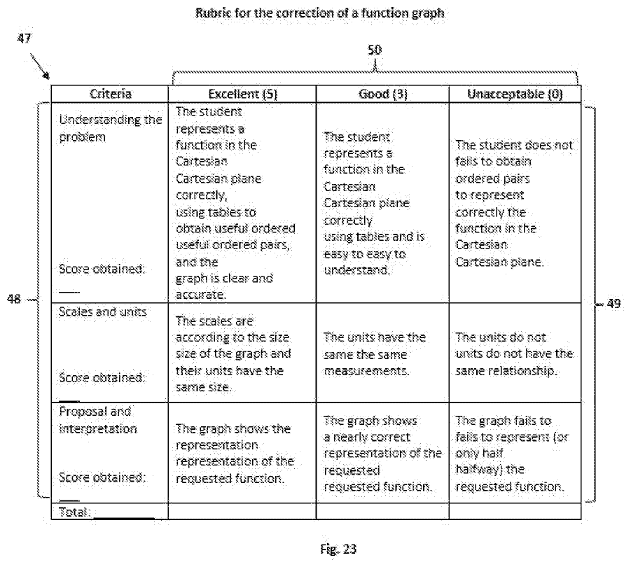

Using formative assessment to improve student performance, the system allows for the student, before submitting an open response exercise within the platform, to consider certain topics or issues that should be involved in the open response that may be lacking. This is done by comparing the students' pre-answer with a rubric (stored in a database) that includes key words or concepts that should be part of the answer. See, FIG. 23. Another way of achieving a similar result is, storing in a database explanations for potential incorrect answers that are prompted when an incorrect answer is submitted by the student. See, FIG. 12. Through this interaction, the platform allows the student to obtain individual results and/or information regarding their performance, as well as the automated correction of conceptual errors behind the incorrect answers or items without necessarily requiring teacher interaction. This is tailored to the manner of responding of the standardized test. Moreover, the system provides for the use of the platform to create other tests to evaluate concepts, skills, standards or bench mark according to the student's needs.

As a result, the system allows the professor to use the components of the platform to identify the strong areas/skills of the students before designing a curriculum; thus, more time is devoted to lagging students and content is accelerated for those students who master it by attending to differentiated instruction in the classroom. The system further allows the platform to provide results to the professor in real time, relieving him or her of the administrative burden involved in grading papers. Results are displayed in the platform through interactive graphs so that the professor can interpret the results and easily identify the lag and/or mastery of skills by student, group and grade. The system allows for the professor to administer tests through the platform and provide results and/or information regarding the students' performance for multiple school subjects or areas of study. However, for the purposes of explaining and illustrating the functionalities of the present disclosure, Applicant includes examples related to the subject of math.

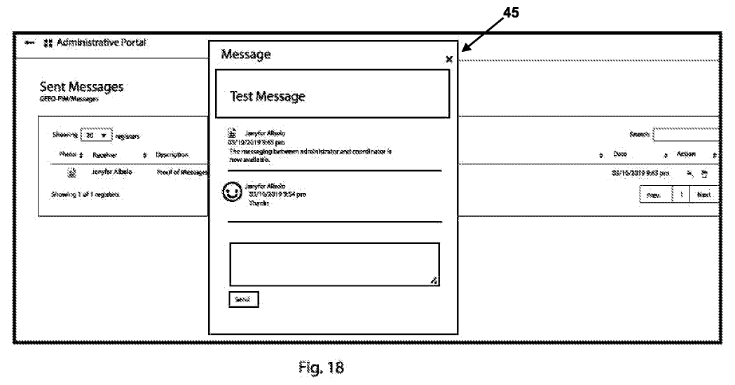

The system keeps count of answered items, which can be displayed in the platform to the student, as well as a message to ensure that the items have been answered and/or are missing before submitting the test responses. During the test, students may move forward or backward between the questions. Also, the professor may allow the student to restart or resume the test if the student mistakenly submits the test. The professor can make available to students and parents, complementary materials or study materials for the teaching process such as videos, notebooks, audios, links, among others. Internal communication is maintained through chats and messages within the platform between users, as shown in FIG. 18, (e.g., the professor and the student, the professor and the parents, the professor and the coordinator, the professor and the principal, the principal and the administrator, among others). The chats allow user assistance within the platform and consistent communication between the users regarding the students' learning process. For example, the school principal or director can view the academic performance of students in a specific subject by student, group, and grade. In addition, the professor can build criteria tests on the platform, to assess the competence of one or all students in real time.

Another of the system's functionalities is the creation of reports, which can be accessed and displayed through the platform. See, FIGS. 13-16. This allows the professor, the school director and the parents/guardians to know how the student, the group or the grade is doing respectively through individual student reports. Specifically, the reports establish which students have mastered a skill and which have not, in order to determine if there are any cognitive gaps within the student, group or grade.

The system performs an automated assessment by using a relational database that associates each question from the tests to a specific standard that is representative of a skill the students must master during each lesson and/or unit. Upon completion of the tests from all students in a group or grade, the system provides the professor an assessment as to the standard(s) and/or skill(s) in which the students from the group or grade were deficient and identifies the lesson/unit that the professor needs to reinforce in order for the students to master the skill associated to said lesson and standard. When the system identifies a pattern of incorrect answers from the tests or impact exams, through the relational database, it can identify the standard and skill associated to the question(s) that was/were answered incorrectly. Once said identification is made, the system will provide the professor, though the platform, the standard and/or skill in which the students, group or grade are lagging and the lesson/unit associated to said standard and/or skill that needs to be reinforced in order for the student to master said skill. This automated assessment collects all incorrectly answered questions from all students that took an impact exam or test. Each question is assigned an identification number (“ID number”) in the relational database. The ID numbers related to the questions answered incorrectly are sorted in order of frequency. For example, the sorting method can be based on the number of questions that were answered incorrectly by most students. The system will retrieve from the relational database the standard, skill and/or unit that is represented by the questions that were answered incorrectly with most frequency. The retrieved information will be displayed, through the platform, to the students, professors and/or parents so that the aforementioned users are appraised of the skills that require improvement. This assessment can be configured so as to provide an analysis for a specific student, group or grade. The system can also provide the professor suggested strategies for reinforcing the skills that require improvement, depending on the identified skill and the number of students that are deficient in said skill. Moreover, the system can reference specific pages and/or sections of the workbook and instruction guide, as defined herein, that the professor and/or student can turn to address and reinforce the identified skills that require improvement.

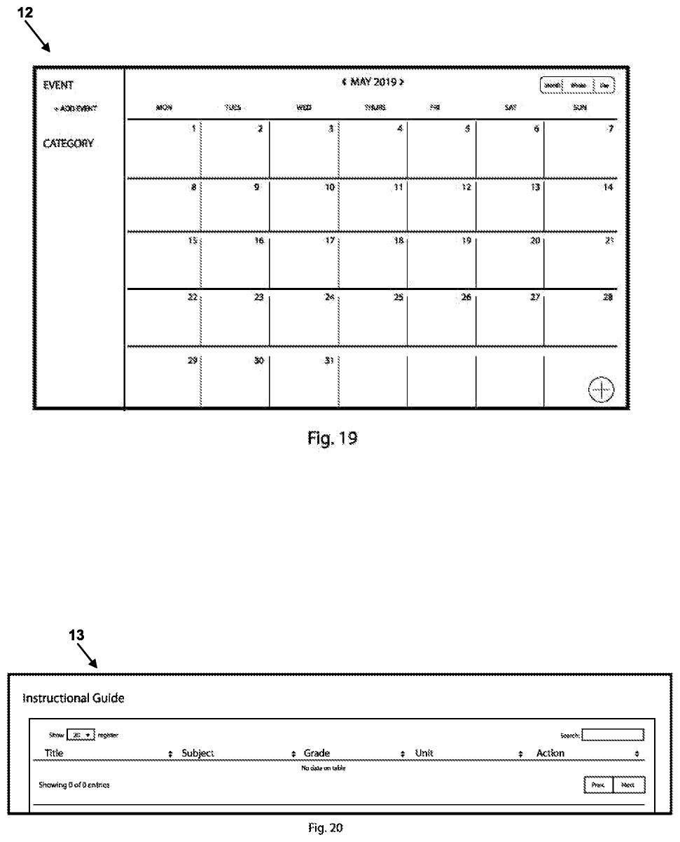

The system also includes a calendar, which can be accessed through the platform, as shown in FIG. 19, in which the users are able to view the student's upcoming tests or assessments scheduled by the professor. The students may also schedule their own study time.

In addition, the system provides different licenses for users to access the information and components within the platform. The licenses consist of different packages that the user may select upon. Each license provides a different scope of access to the platform depending on the user. The system allows for the configuration of multiple users within the platform with different scopes of access and functionalities. The functionality of the platform according to some of the users that may be configured within the platform is shown below.

### Professor:

1. Administration of standardized pre and post-tests of curricular content for different subjects.

2. Access to results in real time by student, group, or grade.

3. Identify lagging skills and student mastery.

4. Access to the instruction guide with explanations of the curricular contents by unit and skill.

5. Access to the student workbook.

6. Internal communication between students, professor, parents and administrative personnel. This is integral to promote the conversation around students learning process.

7. Upload to the platform of complementary material to enrich the curricular content.

8. Create criterion-referenced tests so that students can review concepts or identify whether particular student needs were met.

### Student:

1. Respond to standardized tests in digital format. Instruction on how to analyze descriptors in an item and to develop test taking skills.

2. Access the results in real time.

3. Feedback on the answers to the answered items. When a student completes the assessment response, the student receives formative feedback to promote learning or clarification of an incorrect assumption. This means that an incorrect answer in a multiple-choice question (“closed responses”) will trigger feedback on why potentially the student chose an incorrect answer or why the answer is incorrect, and which is the correct answer and why.

4. Access to test results in real time

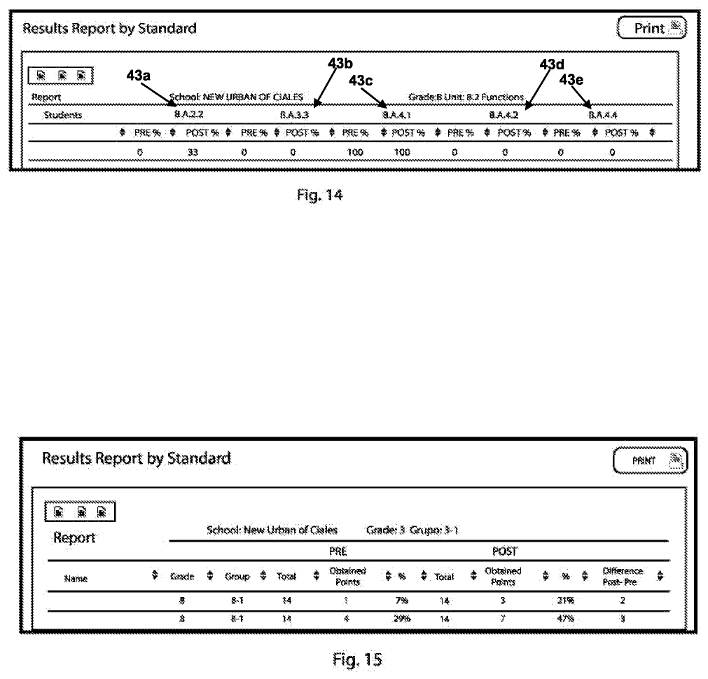

5. Identify the skills that are mastered and those that are not mastered. Each test item is aligned to the acquisition objectives and skills for a specific unit. The skills, in turn, are aligned to grade-level standards and indicators. Therefore, correctly answering the exercises is indicative of mastery of the skill or concept of the unit being worked on. The reporting module provides a report after a test that segregates the students' performance in comparison to the applicable standard, as shown in FIG. 14, so that the teacher can determine the cognitive gaps and prioritize corrective actions.

6. Internal communication with teachers.

7. Access to supplementary material to enrich mastery and non-mastery skills.

### Parents:

1. Internal communication between teachers and administrative staff.

2. Access to results.

3. Identify mastery and non-mastery skills.

4. Access to supplementary material to enrich mastery and non-mastery skills.

### School Principal:

1. Internal communication between teachers, parents and administrative staff.

2. Access to results in real time by student, group and grade, or any other classification. This can be done by incorporating the desired trait in the student or teacher profile and then generating reports based on the desired classifications. For example, the needs of limited Spanish proficient students could be analyzed through this reporting mechanism.

3. Identify the skills that are mastered and those that are not mastered.

In addition to the users defined herein, the system may also allow the configuration of other users based upon the platform's arising needs.

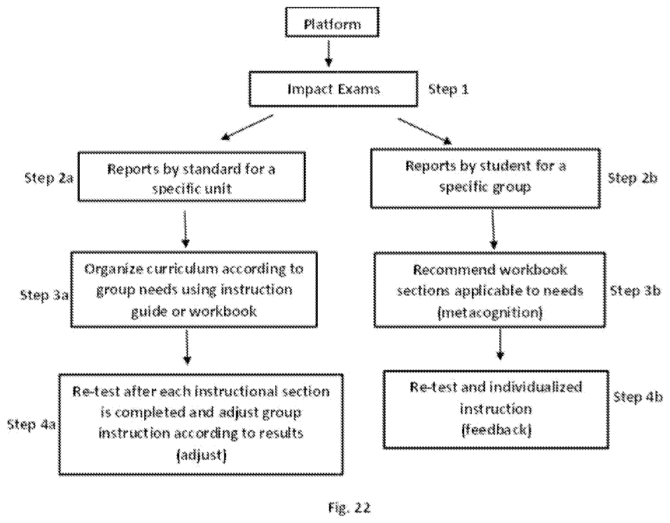

The second component is a student's workbook that allows students to practice what they have learned or continue learning at their own pace. The workbook comprises a plurality of hands-on exercises for all subjects and/or skills included by grade level and aligned with standards and expectations. The workbook avoids gaps in student's formation because it can work offline and avoid internet connectivity glitches that prevent the student from receiving the ordinary teachings offered through remote teaching tools or can even play a role during periods where the student needs to be out of the classroom due to sickness or other issues. The workbook therefore supplements the professor and can be considered a digitized teacher assistant. It also helps the professor by permitting individual work by each student to suit their specific needs, without requiring the professor's complete attention. It is a module by unit which helps the teacher guide the students to help themselves through metacognition. In this context, metacognition is related to knowing your strengths and weaknesses so that you (a student) can address them. By receiving guidance from the teacher, through the results of the impact exams, the students can understand better what skills or subjects they need to address more or more deeply. See, FIG. 22.

Finally, the third component comprises an instruction guide, which allows the professor to practice a concept or topic. It is a module by unit which helps the teacher facilitate instructions to the students. See, FIG. 22. This allows the professor to summarize or review the content using accessible language for the student. In addition, the instruction guide includes exercises with their responses; as well as the steps required to complete the exercises successfully. In this way, if a teacher is not familiar with the content or requires practice to work on a concept, the instructional guide provides it. The exams and instructional guide are accessible through the platform. The workbooks will be distributed to the students in printed format to enable students to complete the exercises included in the workbook. The instruction guide will be visible only on the platform.

In summary of the previous sections, the disclosure presented here is structurally innovative, presents advantages not available at the moment, complies with all new patent application requirements and is hereby lawfully submitted to the patent bureau for review and the granting of the commensurate patent rights.

While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

### DETAILED DESCRIPTION OF THE DRAWINGS

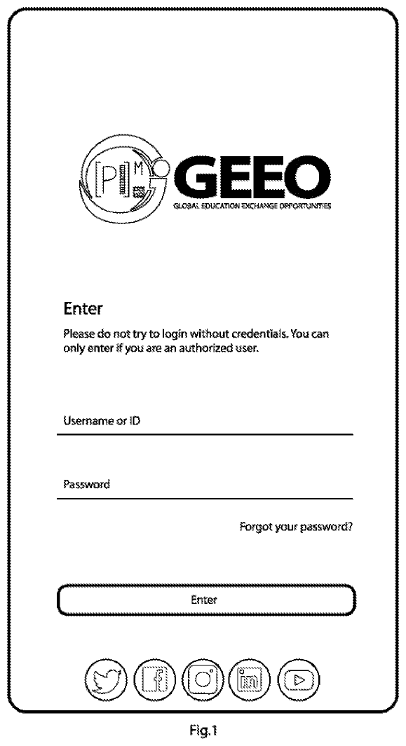

FIG. 1 Shows the user login page to access the platform. Only authorized users can log in to the platform. The platform validates the credentials inserted by the user in order to allow access to the platform.

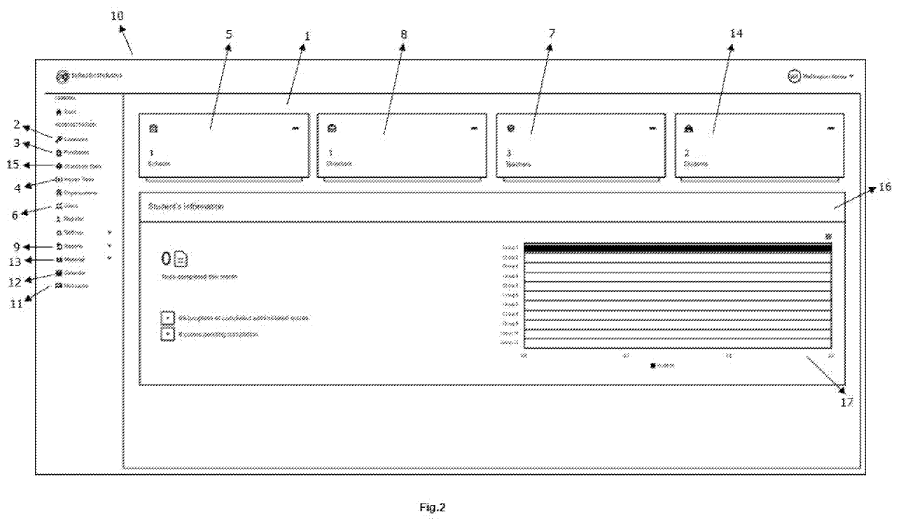

FIG. 2 Shows the dashboard 1 for the administrative portal 10 the administrator will use to keep track of the services provided by the platform. The administrator has access to the administration of licenses 2 within the platform. For example, the administrator can view and manage how many licenses have been purchased 3, the cost of each license, the access that each license provides and/or the term of each license. The administrator can view and create impact exams (Impact Tests) 4, has access to the schools 5 that are registered within the platform, users 6, professors 7, school principals (or directors) 8, reports 9, messages 11, calendar 12, study materials 13 and students 14. The administrator also has access to the question bank 15 that includes questions for the impact exams 4. The administrative portal 10 includes a students' information panel 16, which displays a graph 17 with information as to the total amount of students per group that have taken exams during the current month, the percentage of progress in the administration of tests and the number exams that are pending to be completed. The administrative portal 10 also shows the total amount of schools 5, total amount of school principals (or directors) 8, total amount of professors 7 and total amount of students 12 that are registered in the platform.

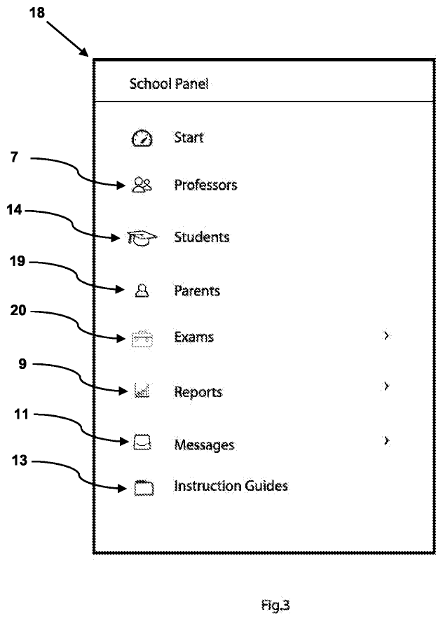

FIG. 3 Shows the school panel 18 for the school principal 8 of the school 5 that is registered within the platform. The school principal 8 has access to the professors 7, students 14, parents 19, the exams menu panel 20, reports 9, messages 11 and study materials 13, which may include instructional guides. The school principal 8 can provide easy communication between the professors 7, students 14 and parents 19, though chats and messages 11.

FIG. 4 Shows the professor portal 18. The professor 7 has access to the students 14, study material 13 that will be provided to the students. The professor can administer, grade, create and/or modify exams, can communicate via messages 11 with parents 19 and/or students 14, can schedule exams and/or other related events in the calendar 12 to which students 14 also have access, and can create reports 9 based on the students' achievement. The professor portal also comprises a dashboard 22 that shows the total amount of grades 23, groups 24, students 14 and impact exams 4 that the professor 7 administers. It also comprises a graph 25 showing the number of students 14 per group 24 per grade 23 and a table 26 showing the status of exams for each group (e.g., the number of exams that have not been started, the number of exams that have or have not been corrected or evaluated).

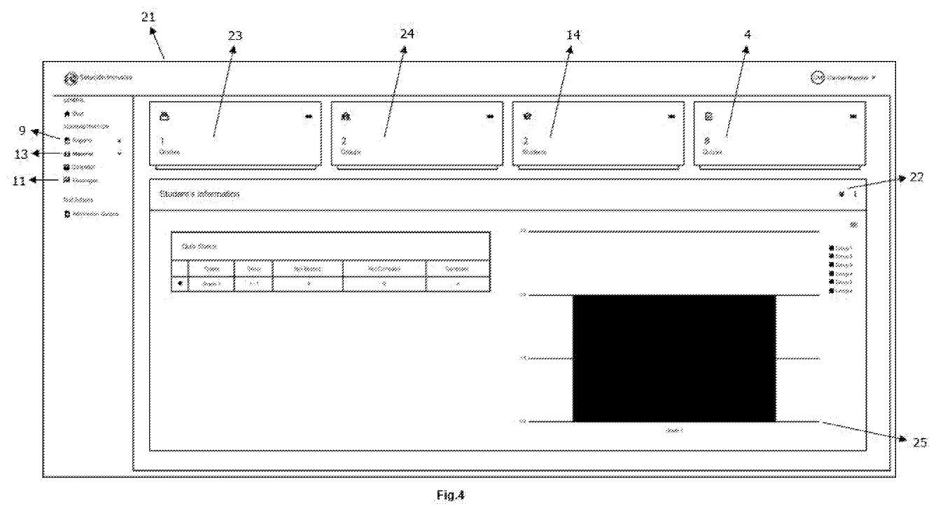

FIG. 5 Shows the student portal 27. The student portal 27 gives access to the students 14 to their professors 7, parents 19, impact exams (quizzes) 4 and study material 13. The students 14 may view their scheduled exams in the calendar 12, and they may also schedule their own study time and/or related events. The student portal 27 also comprises a table 28 that shows the list of exams, the applicable learning unit, the number of questions per test, status of the test and percentage assigned upon evaluation or grading of the exam. If an exam is pending to be completed the student can press the button 29 to take the pending exam.

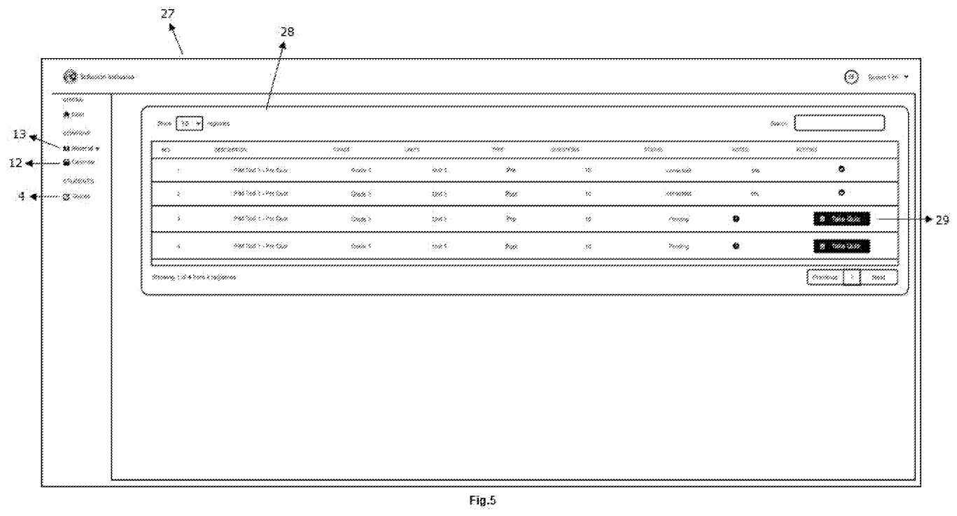

FIG. 6 Shows the parent panel 30. The parents 19 can have access to their children (the students) 14, the professors 7, their children's grades, study material 13 and can communicate with professors 7 or school administrative staff through messages 11.

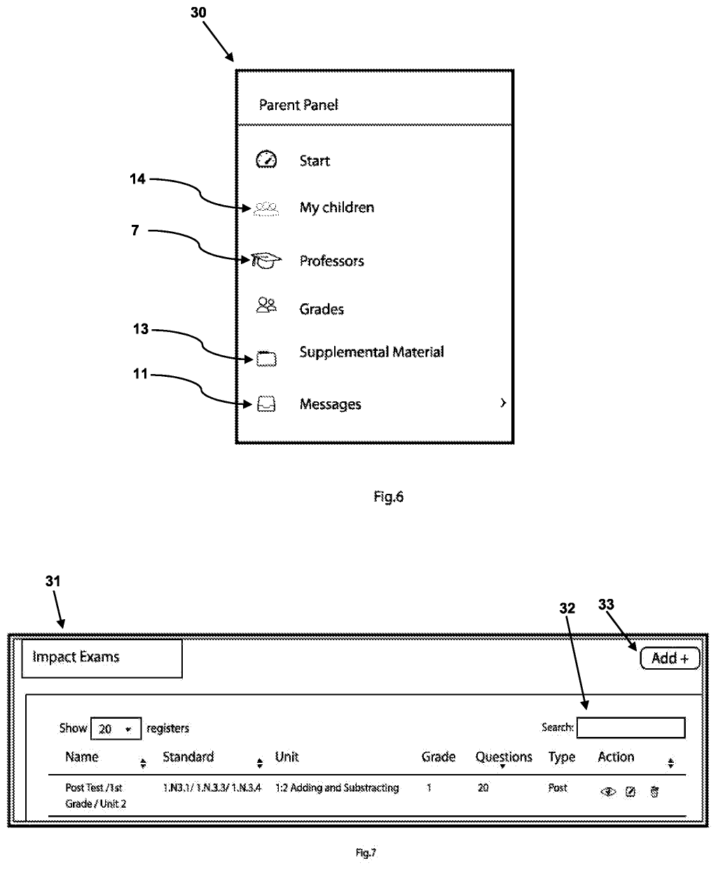

FIG. 7 Shows impact exams list 31. The impact exams list 31 displays information about the available exams, such as, the name of the exam, the unit and corresponding standards that will be evaluated, the number of questions, the grade for which the exam was created, the type of test (e.g., post-test or pre-test) and action to take regarding the exam (e.g., view the exam, grade the exam or erase the exam). Using the search bar 32, the professor may search for a specific exam by inserting any of the aforementioned information. By pressing the “Add” button 33, the professor may create new exams, as shown in FIG. 8.

FIG. 8 Shows the new exams page 34 for the professor to create exams. The professor can determine and insert the name of the exam, the unit and corresponding standards that will be evaluated, the number of questions, the grade for which the exam was created and the type of test (e.g., post-test or pre-test). Once the questions are chosen and the aforementioned information is entered, the professor may press the “Save” button 35 to save and create the new exam.

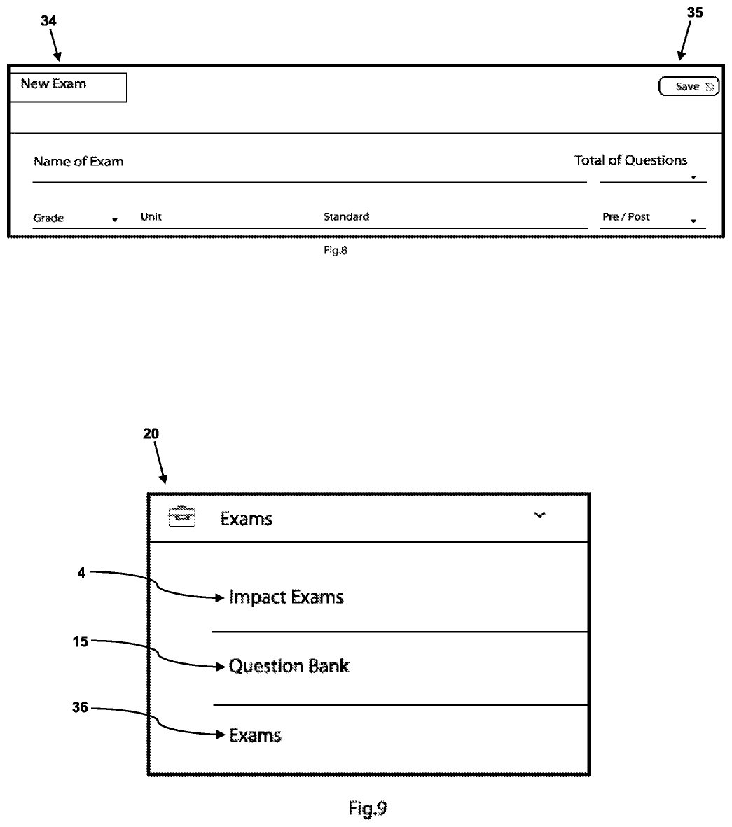

FIG. 9 Shows a drop-down list categorizing information about the exams. When selecting the “Exams” button 20 in the menu panel, the users that have this function available will be able to toggle between Impact Exams 4, Question Bank 15 and Exams 36. The Impact Exams 4 are the standardized tests aligned to particular standards and unit. It is a functionality that allows the teacher to create tests to validate the knowledge of the students (or some of them) in some concept or skill before taking the standardized test. It is an alternative to build other non-standardized tests by concept, skill or standard.

FIG. 10 Shows how a professor grades and gives feedback to the student's open responses. The open responses include a response text box 37 in which the students will insert their responses to the open question shown above the response. When the professor is grading the response a “Feedback” section will be shown beside the “Response” section that includes a grading box 39 to insert the points awarded to the response and a feedback text box 38, to include the professor's feedback if the response is incorrect.

FIG. 11 Shows how an exam is administered to the student. In the left margin, the student will see the name of the exam, which includes if it is a post-test or a pre-test, the unit and grade the exam corresponds to, the time provided to answer the exam and a timer clock showing the estimated time remaining, a “Pause Test” button 40 to pause the exam and a “Finish Test” button 41 to finish and turn in the exam. The top right corner of the screen shows the number of answered questions, the number of remaining questions that have not been answered and the total of questions in the exam. The student will be able to see only one question at a time and will be able to move forward and backward between questions by using buttons 42 that will allow the student to navigate between the next and previous questions.

FIG. 12 Shows how the platform gives feedback to the student's 14 closed responses. If the student answers correctly, the feedback will state that the answer is correct. If the student answers incorrectly, the feedback will state why the student 14 might have chosen an incorrect answer or why the answer is incorrect, and which is the correct answer and why. The feedback may be provided automatically by storing in a relational database explanations for potential incorrect answers that are prompted when an incorrect answer is submitted by the student 14 or they might be added manually by the professor 7. If the student 14 did not answer the question, it will trigger a response stating that the student 14 did not answer.

For example, FIG. 12 shows a conceptual error in a math question product of an incorrect assumption. In that case, the platform will automatically provide an explanation to the student as to the incorrect assumption that was made, why that assumption was incorrect and the assumption that must be made to achieve a correct answer. In this example, the student 14 performed the incorrect mathematical operation and the platform, identifies said incorrect result which prompts the corresponding explanation related to the incorrect response in the database. This is essential for the student's knowledge development because it helps the student 14 understand the concept and theoretical foundation behind the answer, beyond the mechanical procedure, when developing the answer. Therefore, providing clarity as to the student's deficiency in the theoretical foundation that causes the student 14 to make mistakes in the mechanical procedure.

FIG. 13 Shows a drop-down list for the multiple available reports. When the user selects the “Reports” button 9 from the menu panel, the program will show a variety of criteria by which the reports 9 can be issued, such as, by standard, by students, by groups, by units, by standard per student, by skills per student and by group standard.

FIG. 14 Shows the reports by standard for a specific unit. The report 9 is in table format and displays the school, grade and unit for which it is being issued. It includes a column for the students that have taken exams for each of the standards 43a-e within that unit and includes columns for the students' pre-test and post-test grades corresponding to each standard 43a-e within said unit.

FIG. 15 Shows the reports by student for a specific group. The report 9 is in table format and shows the school, grade and group for which it is being issued. The table shows a comparison between the points obtained in the pre-test as opposed to the post-test for each student within the specific group.

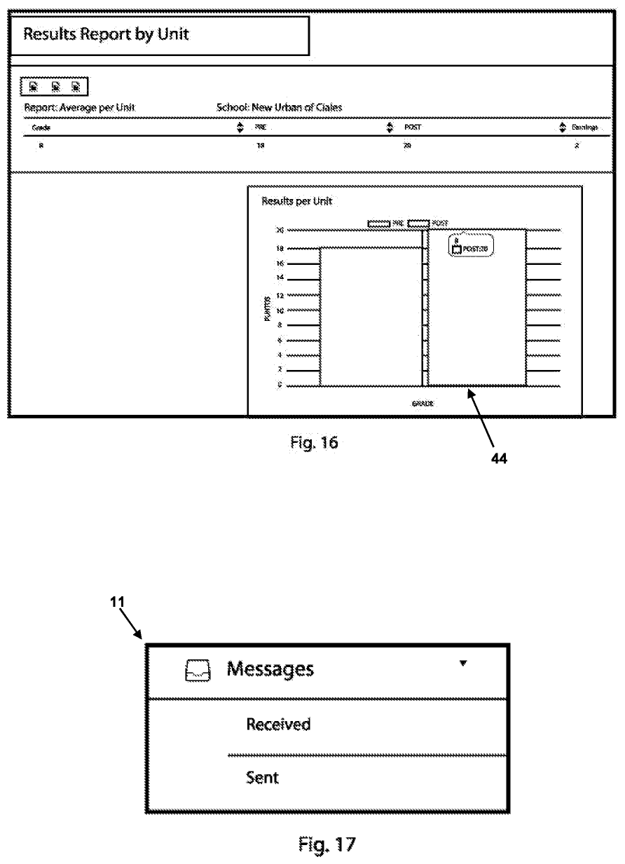

FIG. 16 Shows the reports by unit per grade. The report 9 displays a table and interactive graph 44 comparing the results of the pre-test and post-test for a specific grade.

FIG. 17 Shows a drop-down list to toggle between sent and received messages within the platform. When selecting the “Messages” button 11, the user can toggle between the “Received” and “Sent” buttons from the drop-down list to view the chats and/or messages that have been received and/or sent.

FIG. 18 Shows the messages page within the platform. When selecting the “Sent” or “Received” buttons, the user may see a list of all the chats and the sent or received massages within the platform, the user that has sent or received the message, a description of the subject of the message and the date and time at which the message was sent or received. If the user selects a chat 45 from the list, the user will see the content of the message that was sent or received, and a text box will appear for the user to compose and send a response to said message.

FIG. 19 Shows the calendar page within the platform. The calendar 12 includes a monthly view, a weekly view and a daily view. It allows the user to create and schedule an event and categorize it.

FIG. 20 Shows the instructional guides available on the platform. When selecting the “Material” button 13 from the main menu, the professor 7 will view a list of all instructional guides available by title, subject, grade and unit. The professor 7 will be able to access each instructional guide in the platform.

FIG. 21 Shows the response processor 46 for open responses. The response processor 46 will be available for the mathematics and science questions where an open response is required. The response processor 46 includes a text box, as well as symbols, equations, and other tools the student may need in order to submit a response to the question. The student may also modify the font and size of the text. Once the student is satisfied with the response, the “Accept” button will record the response and the “Cancel” button will discard it.

FIG. 22 Shows a flowchart of the parallel processes performed by the system on the platform. All students 14 are evaluated using the impact exams 4 as a pre-test (Step 1). Once all students 14 are evaluated, the platform will provide the reports 9 by standard for a specific unit for each student 14 (Step 2a) and reports by student 4 for a specific group (Step 2b). Based on the results from the reports 9 obtained for each standard for a specific unit, the platform will organize and develop the curriculum in accordance with the needs identified in the reports 9 for each student 14 by using the instruction guide and/or workbook (Step 3a). The professor 7 will then readminister the impact exams 4 after each instructional section has been completed as a post-test and the platform will adjust the group instruction according to the results obtained from the post-test (Step 4a). Based on the reports 9 obtained for each student 14 for the specific group, the platform will recommend specific sections of the workbook to address the needs for the group identified in the reports 9 for the specific group (Step 3b). The professor 7 will readminister the impact exams 4 as a post-test and the platform will provide individualized instruction for each student 14 according to the results obtained from the post-test (Step 4b).

FIG. 23 Shows an example of a rubric 47 that students 14 can access when answering questions related to a specific topic or skill. In this example, the rubric 47 relates to a function graph. In the rubric, students 14 are appraised of the criteria 48 that is being evaluated when answering questions related to a specific topic or skill. For all criteria 48, the rubric 47 shows the concepts 49 that the student 14 must master in order to master the applicable skill. A score 50 is assigned to the different levels of mastery that the student shows for all criteria 48, when answering the applicable questions.

What is claimed:

1. A method, executing on a digital platform, for identifying a concept or skill in which students are lagging or require improvement to develop strategies, catered to each student, for achieving mastery in said concept or skill, comprising the steps of:
developing and executing impact exams as a pre-test that allows to identify areas of lag in students in accordance with a skill, unit or concept that will be measured to identify areas that require improvement;
developing, using an instruction guide, a teaching lesson aligned to standards that provide valid and accurate information about the performance of students in an academic content area, wherein said instruction guide aids in providing instructions to the students using simple metacognition and summarizes content using accessible language for the student;
providing, through a workbook, a plurality of hands-on exercises for skills, units and concepts by grade level that are aligned with the level of mastery students are expected to achieve;
developing and executing impact exams as a post-test that allows to identify areas of lag in students in accordance with a skill, unit or concept that is being measured in order to determine if a student has mastered said skill, unit or concept;
identifying patterns for specific groups of students, based on the results from the impact exams from each student, to determine areas that require improvement; and
adjusting the teaching lesson and the impact exams in accordance with the identified areas of lag for each student in order for the student to master the skill, unit or concept that required improvement.

2. The method of claim 1, wherein impact exams are executed on a digital platform and are designed on a plugin that uses a response processor with texts and symbols that allow integration of symbols and equations or formulas for writing answers that may require said symbols.

3. The method of claim 1, further comprising generating reports, through the digital platform, using the information from the responses written by students to determine the most common errors committed by students when answering a question from the impact exams.

4. The method of claim 1, wherein the digital platform allows for the student to consider certain topics or issues that may be missing from their answer prior to submitting said answer in the impact exams.

5. The method of claim 1, further comprising providing formative feedback, through the digital platform, to the student on incorrect answers from the impact exam to clarify which is the correct answer and why the chosen answer is incorrect.

6. The method of claims 1, further comprising providing results, through the digital platform, from the impact exams in real time.

7. The method of claim 6, further comprising displaying the results, though the digital platform, in interactive graphs that can be interpreted in order to identify the areas of lag or mastery of skills by student, group or grade.

8. The method of claim 1, wherein the workbook is a remote teaching tool that allows the student to receive ordinary teachings from the teaching lesson when the student is unable to receive said ordinary teachings in a classroom.

9. The method of claim 1, wherein the instruction guide includes exercises with their responses and the steps required to successfully complete the exercises.

10. The method of claim 1, wherein the digital platform includes a calendar for scheduling upcoming impact exams and study time for the student.

11. The method of claims 1, wherein the digital platform allows for internal communication between different users, through messages, promoting conversations related to the students' learning process.

12. The method of claim 1, wherein complementary materials can be uploaded to the digital platform that the students can access to enrich the curricular content from the teaching lessons.

13. A system, executing on a digital platform, for identifying a concept or skill in which students are lagging or require improvement to develop strategies, catered to each student, for achieving mastery in said concept or skill, comprising:
a processing device;
a computer readable storage device;
program instructions configured in the computer readable storage device, the program instructions being executable by the processing device and comprising:
program instructions for developing and executing impact exams as a pre-test that allows to identify areas of lag in students in accordance with a skill, unit or concept that will be measured to identify areas that require improvement;
program instructions for developing, using an instruction guide, a teaching lesson aligned to standards that provide valid and accurate information about the performance of students in an academic content area, wherein said instruction guide aids in providing instructions to the students using simple metacognition and summarizes content using accessible language for the student;
program instructions for providing, through a workbook, a plurality of hands-on exercises for skills, units and concepts by grade level that are aligned with the level of mastery students are expected to achieve;
program instructions for developing and executing impact exams as a post-test that allows to identify areas of lag in students in accordance with a skill, unit or concept that is being measured in order to determine if a student has mastered said skill, unit or concept;
program instructions for identifying patterns for specific groups of students, based on the results from the impact exams from each student, to determine areas that require improvement; and
program instructions for adjusting the teaching lesson and the impact exams in accordance with the identified areas of lag for each student in order for the student to master the skill, unit or concept that required improvement.

14. The system of claim 13, wherein impact exams are executed on a digital platform and are designed on a plugin that uses a response processor with texts and symbols that allow integration of symbols and equations or formulas for writing answers that may require said symbols.

15. The system of claim 13, further comprising instructions for generating reports, through the digital platform, using the information from the responses written by students to determine the most common errors committed by students when answering a question from the impact exams.

16. The system of claim 13, wherein the digital platform allows for the student to consider certain topics or issues that may be missing from their answer prior to submitting said answer in the impact exams.

17. The system of claim 13, further comprising instructions for providing formative feedback, through the digital platform, to the student on incorrect answers from the impact exam to clarify which is the correct answer and why the chosen answer is incorrect.

18. The system of claims 13, further comprising instructions for providing results, through the digital platform, from the impact exams in real time.

19. The system of claim 18, further comprising instructions for displaying the results, though the digital platform, in interactive graphs that can be interpreted in order to identify the areas of lag or mastery of skills by student, group or grade.

20. The system of claim 13, wherein the workbook is a remote teaching tool that allows the student to receive ordinary teachings from the teaching lesson when the student is unable to receive said ordinary teachings in a classroom.

21. The system of claim 13, wherein the instruction guide includes exercises with their responses and the steps required to successfully complete the exercises.

22. The system of claim 13, wherein the digital platform includes a calendar for scheduling upcoming impact exams and study time for the student.

23. The system of claims 13, wherein the digital platform allows for internal communication between different users, through messages, promoting conversations related to the students' learning process.

24. The system of claim 13, wherein complementary materials can be uploaded to the digital platform that the students can access to enrich the curricular content from the teaching lessons.
